(19) United States
(12) Patent Application Publication
(10) Pub. No.: US 2006/0201594 A1
(43) Pub. Date: Sep. 14, 2006

(54) Apparatus for carrying items

(76) Inventor: Sandra Carmichael, Wingdale, NY (US)

Correspondence Address: ST. ONGE STEWARD JOHNSTON & REENS, LLC, 986 BEDFORD STREET, STAMFORD, CT, 06905-5619, US

(21) Appl. No.: 11/249,895

(22) Filed: Oct. 13, 2005

Related U.S. Application Data
(60) Provisional application No. 60/619,059, filed on Oct. 15, 2004.

(51) Int. Cl. A45C 1/06; A61C 19/10

(52) U.S. Cl. 150/143; 206/83

(57) ABSTRACT

A low-profile wallet apparatus for securing relatively small items to a person that may be opened with one hand, the wallet having a closure mechanism to secure a first portion to a second portion, the closure system being provided to create a seal to securely maintain the items in the wallet. The wallet, or at least portions thereof may advantageously be provided of a wicking or breathable material.

### PRIOR APPLICATION

Applicant claims priority benefits under 35 U.S.C. §119(e) of U.S. Provisional patent application Ser. No. 60/619,059 filed Oct. 15, 2004.

### FIELD OF THE INVENTION

The present invention relates to an apparatus for carrying items on the person, and more specifically to an apparatus for securing relatively small items to a person's limb.

### BACKGROUND OF THE INVENTION

Methods and means for carrying items on one's person have been in wide use for many years. For instance, wallets and purses for carrying relatively small personal items have been widely utilized for many decades.

One disadvantage that these carrying means have however, is that one may easily loose a wallet or purse, either through negligence of the user or because the wallet or purse is for instance, stolen. It is especially important to secure particular items in a secure location, such as when traveling, including but not limited to for instance, cash or checks, a passport or other identification, or even travel passes.

A number of systems have sought to overcome some of these limitations by providing devices that may be attached to the person either inside or over top of one's clothing, for instance, around their torso or hanging from one's neck. None of these systems however, provide for easy access to the items stored therein or provide for a neat and low-profile appearance which can be critical if one is seeking to protect important items.

Other systems have been provided for securing items to person's limbs, however, each of these have provided either insecure due to the item having to be removed from the person to access, or difficult to operate closure systems.

For example, U.S. Pat. No. 4,763,821 (“the ′821 patent”) discloses a wallet assembly for detachably securing to an individual's ankle that includes pockets and is foldable across the front. The closure system is a hook and loop type fastener. However, the closure system of the ′821 patent is a three-section folding apparatus, where one section lays against the user's ankle, a second section folds over the first, and a third section closes over the second in the manner of a typical hook and loop type fastener wallet. The second and third section is provided with hook and loop type fasteners to engage with each other. This is a very cumbersome system if, for example, this configuration were used as a wrist wallet because two hands are required to operate this closure system. This would typically require the user to remove the apparatus to operate the closure mechanism, which is highly undesirable. While fairly secure, the elongated hook and loop fasteners make this apparatus very difficult to operate.

U.S. Pat. No. 5,341,972 (“the ′972 patent”) discloses a combination wrist-watch wallet apparatus having a main band with a watch attached to the outer surface thereof. The main band is made of a flexible material of a length sufficient to be wrapped around the user's wrist in an overlapping manner. The opposite ends of the main band are provided with complimentary hook and loop connector pads, which are interconnected to hold the main band in place around the user's wrist. Again, however, while this closure system may be actuated with one hand, albeit difficultly, the entire apparatus must be removed from the user's wrist to access the wallet. This is highly undesirable.

U.S. Pat. Nos. 5,755,366 (“the ′366 patent”) and 5,588,571 (“the ′571 patent”) disclose a waterproof wallet and pouch combination that can be worn around the wrist with a wallet secured to the pouch. The wallet is inserted into the pouch through an opening in the end of the pouch. However, a problem with this system is that again, the wallet must be removed from the apparatus to be opened. This compromises security because the wallet must be detached from the person and may become lost or misplaced, or even stolen.

U.S. Pat. No. 6,223,958 (“the ′958 patent”) discloses a device for holding a pouch again a wrist with the aid of a watch band. The pouch is generally L-shaped and attaches to a watch band utilizing a standard hook and loop fastening system. Once folded over on itself, a pocket is created, and a end portion may be folded over to cover the opening of the pocket. However, a problem with the ′958 patent is that it must be worn in connection with a watch band or some other securing member not provided with the product. Additionally, the size of the apparatus is very limited due to it being secured to a watch band, and is too small to hold, for example, credit cards, ID, money, a cellular telephone, etc.

U.S. Pat. No. 6,443,341 (“the ′341 patent”) discloses a wrist wallet, substantially made of mesh fabric, having laterally positioned pockets. The pockets are provided with an elongated sealing element in the form of a zipper that extends circumferentially around one end of the apparatus. The wallet also uses a hook and loop arrangement as an attachment means to secure the wallet about the wearer's wrist. However, the ′341 patent utilizes a zipper arrangement that extends circumferentially around the wearer's wrist, which means that the apparatus may not be slide over the user's limb. Rather, this device must be severed longitudinally so that it may applied/removed from the user's limb. This is disadvantageous because this device cannot be provided as a one-size-fits-all arrangement with, for example, and elastic member that may be slipped over the user's hand to tightly hold the device against the user's wrist. This limitation is inherent in the use of the zipper arrangement because the circumferential zipper cannot stretch over the user's hand and tightly conform to the wrist.

What is desired then is an apparatus and method for storing and protecting relatively small items on a person's wrist or arm that may easily be accessed with one hand.

It is further desired to provide a system and method for storing relatively small items on a person's wrist or arm that uses a secure closure mechanism that will not wear out or become unsightly with use.

It is still further desired to provide a system and method for storing relatively small items on a person's wrist or arm that uses a simple, reliable closure mechanism such that the contents of the wallet may be accessed and/or displayed without having to remove the wallet from the user's wrist.

### SUMMARY OF THE INVENTION

These and other objects are achieved in one advantageous embodiment where an apparel device is provided with a storage space located therein that may be directly attached to a person's limb, such as for example, an arm or wrist.

As used herein, the terms “first” and “second” are used to distinguish one element, object or thing from another, and are not used to designate or limit objects by relative position or to a particular arrangement.

The apparatus, described herein, may enclose the wrist with the storage space accessed on an inside portion of the wrist. The storage may take many forms such as a wallet, ID carrier, cell phone carrier, mini-purse, coin purse, etc.

It is contemplated that the outside portion, or top part of the arm or wrist mounted device may further be decorative. Many differently types of materials and fabrics may be utilized for fabrication of the apparatus and for example, may be custom ordered to include virtually any configuration according to the user's preferences. It is contemplated that the fabric may comprise a wicking fabric or a mesh that will draw moisture away from the skin and/or allow for air circulation so that the wallet does not become uncomfortable and/or hot against the skin.

It is still further contemplated that the apparatus may be provided with a highly secure closure system that may be operated with one hand. The closure system is provided as a magnetic closure apparatus that maintains the wallet in a secure closed state. The magnets may effectively be utilized to hold, for instance, a front cover closed by means of a metal boarder such as steel balls located around the perimeter of the flap, which can engage with a magnet(s) or magnetic strip located on the opposite portion. It is still further contemplated that multiple covers may be sequentially flipped out as needed providing still more security. Alternatively, opposite polarity magnets may be provided on opposing surfaces to securely maintain the wallet in a closed position. It is further contemplated that the magnetic closure system may be provided with magnetic shielding such that the magnetic field(s) generated by the magnets are directed or are impeded. This will allow, for example, any magnetic stripes on credit cards to maintain their magnet properties while being stored in the wallet.

While the magnetic closure system is preferred, it is further contemplated that other low-profile closure systems that may be activated by one hand could be used with an ID carrier or wallet. For example, snaps or buttons, may individually be used or in combination with the magnetic closure system as described above. Alternatively, a hook and loop type fastener and zipper may also be variously utilized.

The wallet or ID carrier may be provided as a decorative wrist band having at least one pocket located therein for storing relatively small items. The pocket(s) may be accessed either by opening the closure mechanism to access the pocket, which may be called a lateral pocket arrangement. Alternatively, the closure mechanism may be opened to flip a portion(s) of the wallet or ID carrier outward, thereby allowing access to a pocket(s) located therein, which may be called a folding pocket arrangement.

In addition, a window for a driver's license or identification card may be provided in, for example, the folding pocket arrangement, that may be flipped open along with other means to hold items such as netting and/or credit card slots, etc.

The apparatus may further be combined with a number of other items typically carried on one's person. For instance, the apparatus may be combined with a watch, with jewelry, could contain a mirror, a compact or any manner of pocket findings. These examples are provided to illustrate only a few of the many applications where the invention may be utilized. The device may further be adapted for carrying electronic equipment, such as, for example, a cellular telephone, a pocket organizer and the like.

In one advantageous embodiment, a wallet for carrying items to be secured to a user is provided comprising, a body portion including at least one pocket therein for receiving the items to be secured. The wallet is provided such that the body portion includes a first body portion maintained adjacent to the user, and a second body portion that may be displaced so as to provide access to the items. The wallet further includes, an attachment mechanism for attaching the body portion to the user, and a closure system for maintaining at least an edge of the first and second body portions in proximity to each other to secure the items in the body portion. The wallet is further provided such that the closure system includes a first magnetic system in the first body portion and a corresponding second magnetic system in the second body portion such that at least the edges of the first and second body portions are maintained in a closed position relative to each other due to magnetic force between the first and second magnetic systems.

In another advantageous embodiment, a wallet for carrying items to be secured to a user is provided comprising, a body portion including at least one pocket therein for receiving the items to be secured. The wallet is provided such that the body portion includes a first body portion maintained adjacent to the user, and a second body portion that may be displaced so as to provide access to the items. The wallet further includes, an attachment mechanism for attaching the body portion to the user, the attachment mechanism comprising a wicking material, and a closure system for maintaining at least an edge of the second body portion in proximity to the first body portion to secure the items in the pocket. The wallet is further provided such that the closure system is selected from the group consisting of: a magnetic closure system, a button closure system, a snap closure system and combinations thereof.

In still another advantageous embodiment, a wallet for carrying items to be secured to a user's wrist is provided comprising, a body portion, having a longitudinal axis and including at least one pocket therein for receiving the items to be secured. The pocket is formed at least in part by a first body portion maintained adjacent to and extending circumferentially around a wrist of the user and comprising an elastic, wicking material, and a second body portion that is, displaceable relative to the first body portion, so as to provide access to the items. The wallet further comprises, a closure system for maintaining at least an edge of the second body portion in proximity to the first body portion to secure the items in the pocket. The wallet is provided such that the closure system is selected from the group consisting of: a magnetic closure system, a button closure system, a snap closure system, a longitudinally extending zipper closure system and combinations thereof.

In yet another advantageous embodiment, a secure wallet apparatus is provided for carrying a mobile device to be secured to a user's wrist. The wallet apparatus comprises a body portion, having a longitudinal axis and including a first body portion maintained adjacent to the user's wrist and a second body portion that is displaceable relative to the first body portion. The wallet apparatus further comprises a first pocket, formed of a transparent material located in said first body portion, and a second pocket, formed of a transparent material located in the second body portion. The wallet apparatus is provided such that the first pocket designed to receive a first part of a mobile device and the second pocket designed to receive a second part of a mobile device. In addition, when the mobile device is inserted into the first and second pockets, the mobile device may be opened and used while simultaneously being attached to the user's wrist such that the device need never be removed from the wallet for normal use.

Other features and advantages of the present invention will become apparent from the following drawings which illustrate some of the advantageous embodiments.

### BRIEF DESCRIPTION OF THE DRAWINGS

FIG. 1 is an illustration of one advantageous embodiment of the present invention showing the wallet in a closed position.

FIG. 2 is an illustration of the wallet according to FIG. 1 showing one configuration of the wallet in an open position.

FIG. 3 is an illustration of the wallet according to FIG. 1 showing another configuration of the wallet in an open position.

FIG. 4 is an illustration of the wallet according to FIG. 1 showing still another configuration of the wallet in an open position.

FIG. 5 is an illustration of a variation of the wallet according to FIG. 1 shown in a closed position.

FIG. 6 is illustration of the wallet according to FIG. 5 shown in an open position.

FIG. 7A is an illustration of the wallet according to FIG. 1 showing one configuration of a closure system.

FIG. 7B is an illustration of the wallet according to FIG. 1 showing another configuration of a closure system.

FIG. 8 is an illustration of another advantageous embodiment of the present invention according to the wallet shown in FIG. 1.

FIG. 8A is an illustration of the wallet according to FIG. 8 illustrating one closure system.

FIG. 8B is an illustration of the wallet according to FIG. 8 illustrating another closure system.

FIG. 8C is an illustration of the wallet according to FIG. 8 illustrating still another closure system.

FIG. 8D is an illustration of the wallet according to FIG. 8 illustrating yet another closure system.

FIG. 8E is an illustration of the wallet according to FIG. 8 illustrating still another closure system.

FIG. 8F is an illustration of the wallet according to FIG. 8 illustrating yet another closure system.

FIG. 8G is an illustration of the wallet according to FIG. 8 illustrating another configuration.

FIG. 9 is an illustration of the wallet according to FIG. 1 in yet another configuration shown in a closed position.

FIG. 10 is an illustration of the wallet according to FIG. 9 shown in an open position.

FIG. 11A is an illustration of the wallet according to FIG. 1 in still another configuration shown in a closed position.

FIG. 11B is an illustration of the wallet according to FIG. 11 A shown in an open position.

FIG. 11C is an illustration of the wallet according to FIG. 11 B illustrating the attachment of a device.

FIG. 12A is an illustration of the wallet according to FIG. 1 in yet another configuration shown in a closed position.

FIG. 12B is an illustration of the wallet according to FIG. 12A shown in an open position.

FIG. 12C is another illustration of the wallet according to FIG. 12B.

### DETAILED DESCRIPTION OF THE DRAWINGS

Referring now to the drawings, wherein like reference numerals designate corresponding structure throughout the views.

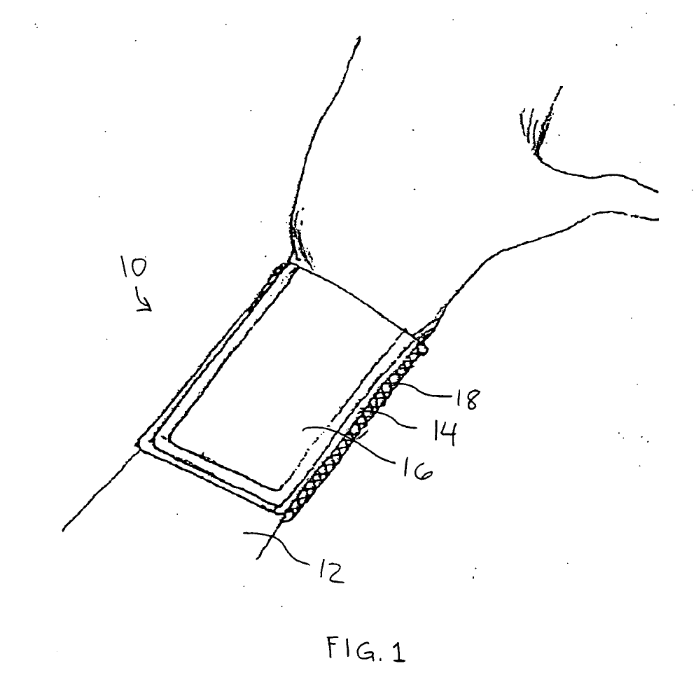

FIG. 1 illustrates wallet apparatus 10 positioned on a user's limb 12. The wallet apparatus 10 comprises a body portion 14 for receiving items to be stored therein. An outer surface 16 of body portion 14 may be provided of virtually any type of fabric or composition and further may be provided with virtually any type of color and/or design pattern.

Also shown in FIG. 1 is attachment mechanism 18, which, in this embodiment is shown as a mesh material. It should be noted that while attachment mechanism 18 is illustrated here comprising a mesh, virtually any type of attaching medium may be effectively be used to maintain body portion 14 against limb 12. For example, attachment mechanism 18 may comprise a solid piece of material extending circumferentially around limb 12, or may comprise any combination of straps, cords, fabric, mesh, ties, ribbons, decorative items, and the like, alone or in any combination, that can extend around limb 12 to maintain body portion 12 adjacent thereto.

In addition, it is contemplated that attachment mechanism 18 may comprise one or more detachable items as described above. Further, attachment mechanism 18 may comprise in one advantageous embodiment, an elastic material that may be stretched, for example, over the users hand or foot to snuggly hold body portion 14 against limb 12.

Still further, it is contemplated that attachment mechanism 18 will comprise a wicking material that will have a tendency to draw moisture away from a user's skin. This provides the advantage that, even though the wallet is tightly secured to the user's limb 12, it will not become uncomfortable for the user. A mesh material may further be used, having the advantage of allowing the air to circulate to the skin of the user to prevent undo build-up of moisture. Any one or combination of materials may effectively be used to increase the comfort level for the user.

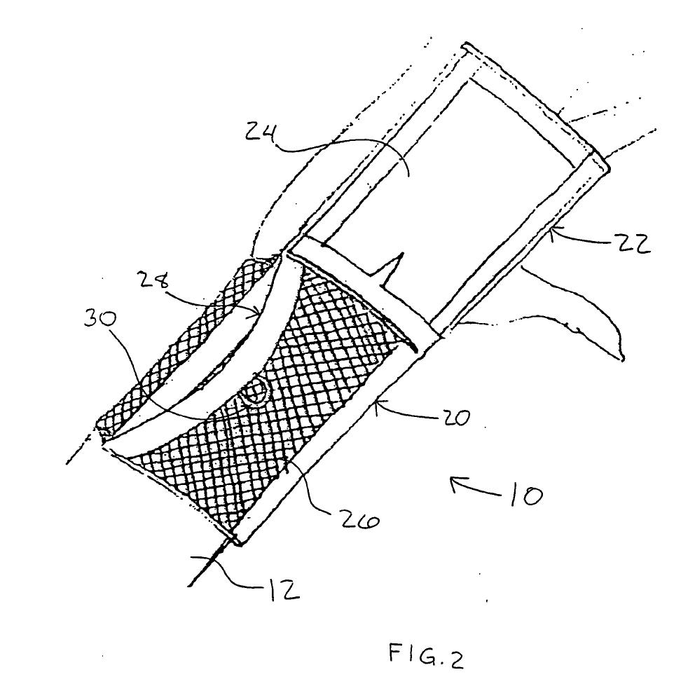

Turning now to FIG. 2, an advantageous embodiment of wallet apparatus 10 is illustrated in an open position. It can now be seen that, in this advantageous embodiment, body portion 14 comprises a first body portion 20 and a second body portion 22. First body portion 20 is maintained adjacent to limb 12, while second body portion 22 is moveable with respect to first body portion 20 as shown. For example, if the user wishes to access the items stored in wallet apparatus 10, he/she merely needs to grasp second body portion 22 and flip it open with respect to first body portion 20. It should be noted that this is a simple and easy to perform step, requiring only one hand to accomplish.

As can also be seen in FIG. 2, a transparent window or pocket 24 is provided as part of second body portion 22. In this manner, it is contemplated that an identification card, such as for example, a driver's license, school ID card, office ID card, or photo identification card may be easily presented for inspection without having to remove the card from the window or pocket 24.

Also provided in FIG. 2 is pocket 26, which in this particular embodiment, is illustrated as a mesh fabric. Mesh fabric is desirable because it allows the user to visually inspect the contents of pocket 26 without having to actually open the pocket. However, it is contemplated that pocket 26 may comprise virtually any type of fabric as may be desired. Provided at an edge 28 of pocket 26 is handle 30, which is provided for the user to grasp when opening pocket 26. While second body portion 22 is illustrated as not having a handle, it is further contemplated that a handle may be provided as desired. It should also be noted that, while the transparent window or pocket 24 is shown located in second body portion 22 and the pocket 26 shown as the mesh fabric is shown located in first body portion 20, these are interchangeable. Further, both pockets 24, 26 may be provided as a transparent window or as a mesh fabric.

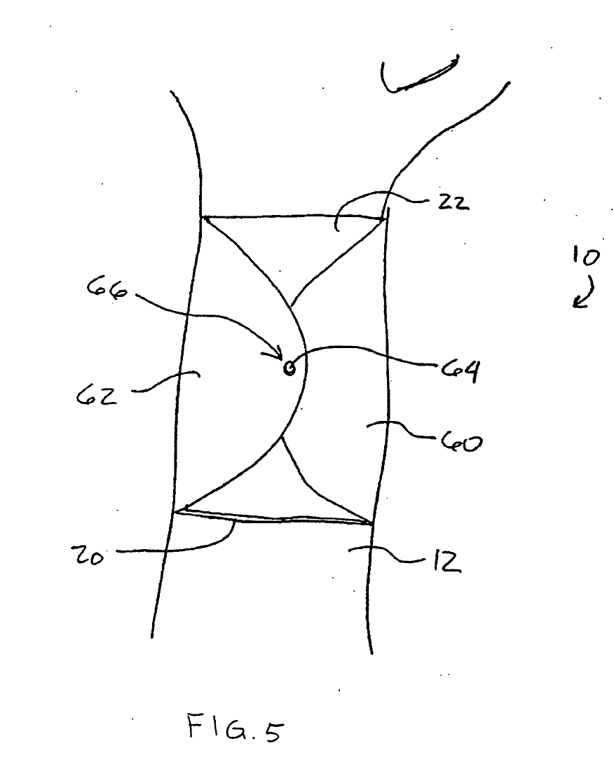

Referring now to FIGS. 7A and 7B, one advantageous embodiment of closure system 44 is illustrated. Closure system 44 comprises first magnetic system 32, which is located near edges 34, 36 of first body portion 20. In this particular embodiment, first magnetic system 32 comprises two sets of four magnets positioned along edges 34, 36. It is contemplated however, that any number of individual magnets may effectively be utilized.

Second magnetic system 38 is also illustrated located near edges 40, 42 of second body portion 22. Again, while in this illustration, second magnetic system 38 is shown comprising two sets of four magnets positioned along edges 40, 42, any number of individual magnets may effectively be used.

Accordingly, it is a relatively simple matter to open closure system 44. The user simply has to grasp second body portion 22 and pull upwardly with enough force to overcome the attractive magnetic force of closure system 44. In this particular embodiment, it is contemplated that magnets of opposite polarity may effectively be positioned opposite each other in first and second body portions 20, 22 to provide closure system 44.

FIG. 7B shows an alternative embodiment including closure system 44′. Closure system 44′ includes first magnetic system 32 positioned in first body member 20 as described in FIG. 7A. However, second magnetic system 38′ positioned near edges 40, 42 of second body member 22 comprise steel balls. Closure system 44′ therefore operates similarly to closure system 44 except, rather than positioning opposite polarity magnets to each other, magnetically attractive material, such as steel balls, are positioned along the perimeter of edges 40, 42 to engage with first magnetic system 32.

While first and second magnetic systems 32, 38 are shown on the edge portions of first and second body members 20, 22, it is further contemplated that an additional magnet(s) may be positioned along ends 50, 52 of first and second body portions 20, 22.

Referring back now to FIG. 2, wallet apparatus 10 may easily be provided with, for example, but not limited to, closure system 44 or closure system 44′. In this manner, it is a simple matter for the user to flip open second body portion 22 to access any items stored therein.

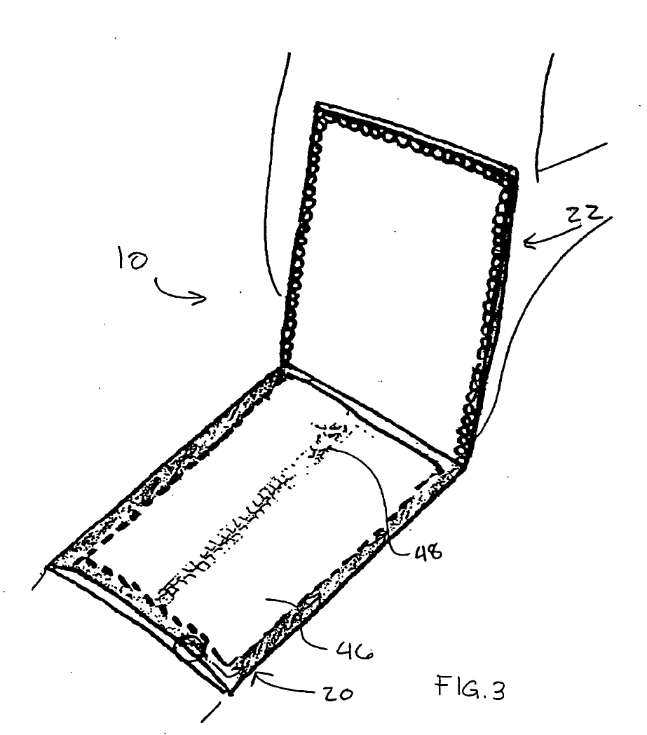

Turning now to FIG. 3, an alternative embodiment wallet apparatus 10 is here depicted. Here, pocket 46 is illustrated and accessible by means of zipper 48 positioned in first body member 20. Zipper 48 is positioned under second body portion 22 when closed so as not to present a protrusion on the exterior surface of wrist wallet apparatus 10, which may easily become snagged with clothing. Again, pocket 46 may comprise virtually any type of material similar to pocket 26.

FIG. 4 illustrates yet another embodiment of the present invention showing wallet apparatus 10 in an open position. In this embodiment, pocket 54 is provided that may comprise, for example, a coin purse. Pocket 54 is located on first body portion 20, and includes a folding portion 56, which may be secured by a snap or button 58. Alternatively, snap or button 58 may be replaced with a magnetic component that magnetically maintains folding portion 56 in a closed position. Again, pocket 54 may comprise virtually any type of material similar to pocket 26.

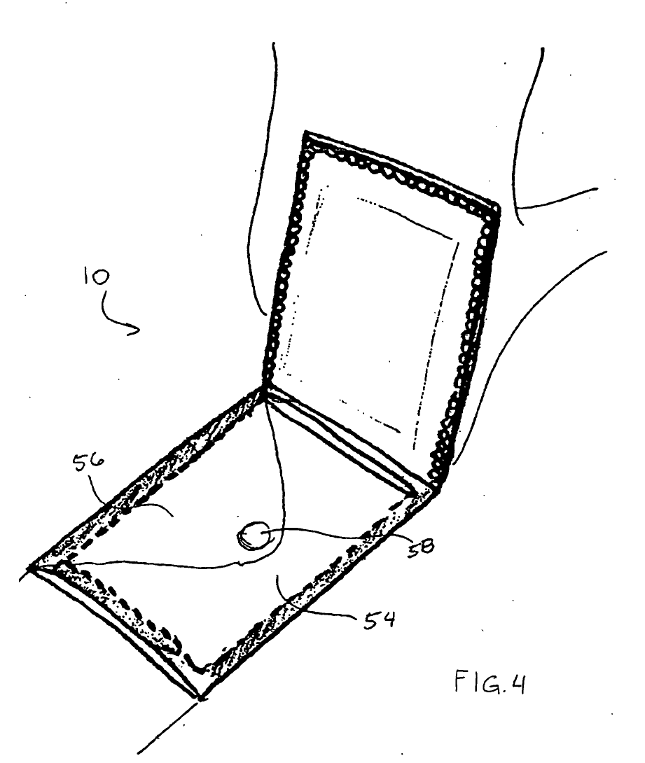

FIG. 5 illustrates still another advantageous embodiment of wallet apparatus 10 positioned on limb 12. In this embodiment, wallet apparatus 10 further comprises first overlapping section 60, and second overlapping section 62. First and second overlapping sections 60, 62 may be secured to one another via, for example, a snap or button 64 forming closure system 66. Alternatively, snap or button 64 may effectively be replaced with a magnetic component or even a hook and loop type connector.

Turning now to FIG. 6, we see the embodiment of FIG. 5 in an open position. Here, first and second overlapping sections 60, 62 have been detached from one another and flipped outwardly. In addition, second body portion 22 has been flipped up to allow access to any items that may be stored therein.

It is contemplated that this closure system 66 may effectively be used along or in connection with, for example, closure systems 44, 44′ previously discussed.

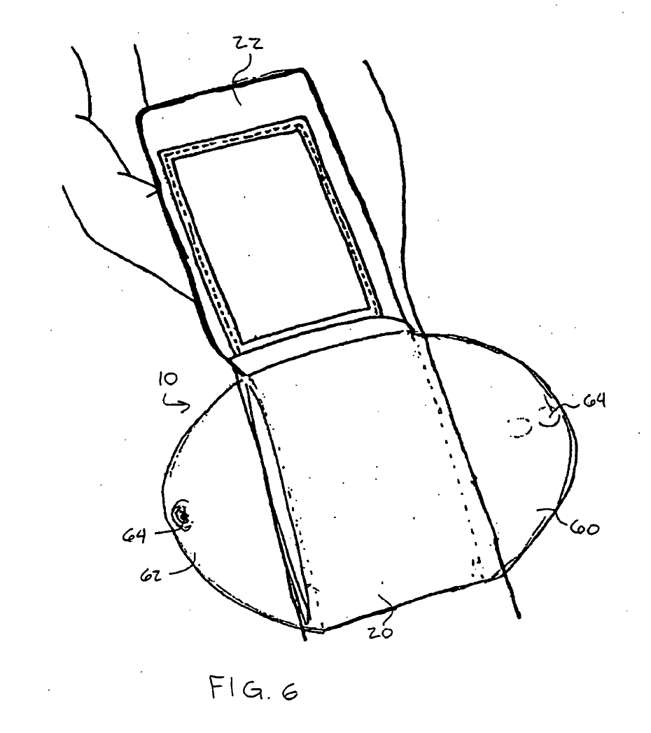

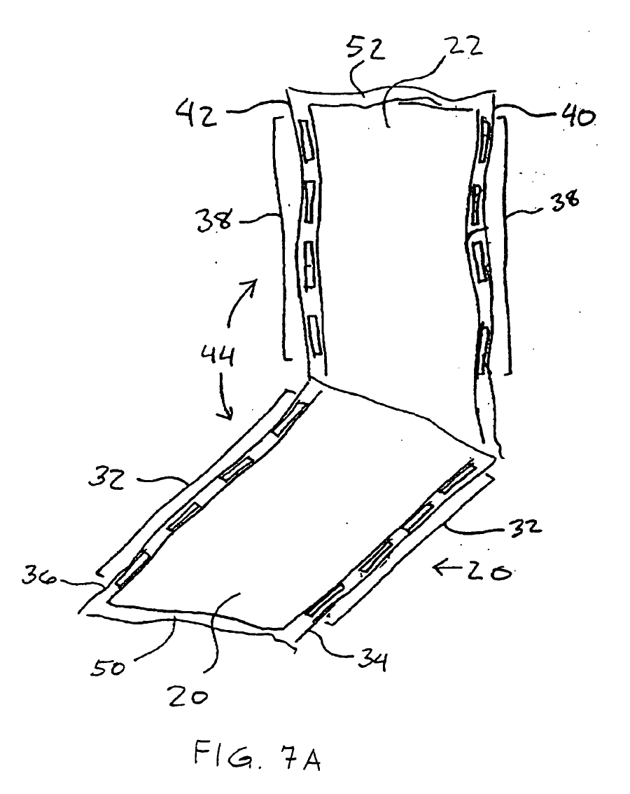

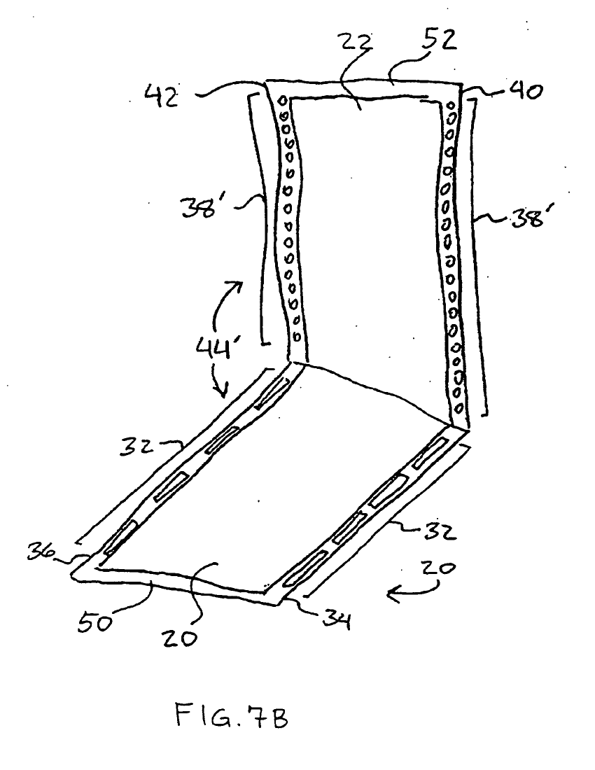

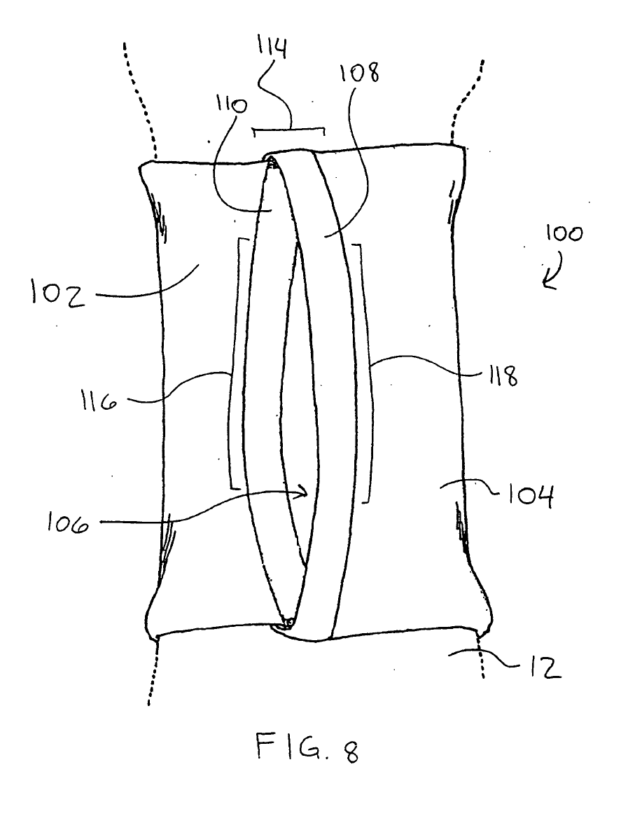

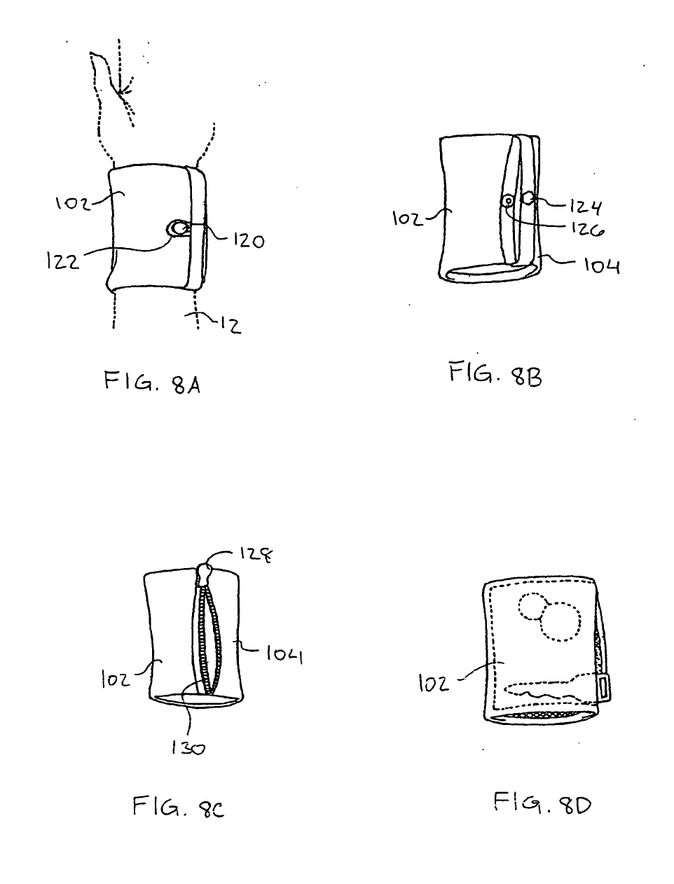

Referring now to FIGS. 8-8G, another advantageous embodiment of the invention is illustrated. Here, wallet apparatus 100 is illustrated on limb 12 in a closed position. Wallet apparatus 100 is here comprised of a first body portion 102 and a second body portion 104. Second body portion 104 overlays at least part of first body portion 102 to form a pocket 106, which is variously illustrated in FIGS. 8A-8G. Wallet 100 is held adjacent to limb 12 by means of an elastic material that extends around limb 12, such that wallet 100 may easily be fitted over, for example, the user's hand to fit tightly against the user's wrist.

First and second body portions 102, 104 may comprise virtually any manner of material or fabric as previously described herein and preferably comprise a wicking material to draw moisture away from the user, and further may comprise a mesh type material, at least on the back side of wallet 100 so as to allow breathing of the material.

Also illustrated in FIG. 8 is edge 108 of second body portion 104, and edge 110 of first body portion 102. Optionally, a handle 112, may be connected to edge 108, which may be grasped by the user to open and access the items contained within pocket 106 as illustrated, for example, in FIG. 8E. The configuration illustrated in FIG. 8 may be called, a lateral pocket configuration.

Closure system 114 is also illustrated in FIG. 8. For example, closure system 114 may comprise, various configures positioned in or on edges 108, 110 of first and second body portions 102, 104 respectively, as illustrated in FIGS. 8A-8G.

FIG. 8A illustrates a button-type closure system 114, including a button 120 and a loop connector 122. FIG. 8B illustrates another configuration of closure system 114 including a snap-type connector 124, 126. It should be noted that, while only one button 120 and one snap 124, 126 are illustrated in these embodiments, any number may effectively be utilized to further secure items in wallet 100.

FIG. 8C illustrates a zipper-type closure system 114, including a zipper head 128 and zipper teeth 130. FIG. 8D illustrates a magnetic-type closure system 114, which may be similar to the magnetic systems discloses in connection with FIGS. 7A and 7B.

FIG. 8E illustrates a hook and loop-type closure system 114, including hook 132 and loop 134 fasteners. Also included in this embodiment is tab or handle 112, provided so that the user may easily grasp and open wallet 100. FIG. 8F illustrates another embodiment, showing a combination of the magnetic closure system 114 per FIG. 8D and the hook and loop-type closure system 114 per FIG. 8E. This may provide yet further security for items located in wallet 100.

FIG. 8G illustrates still another embodiment, showing a configuration of wallet 100 according to FIG. 8, in which an opening 136 is provided for an antenna of a cell phone to extend through. It is contemplated that any of the closure systems 114 may effectively be used in connection with the configuration illustrated in FIG. 8G. It is also contemplated that any of the above-described closure system 114 embodiments may be used in connection with each other in various combinations.

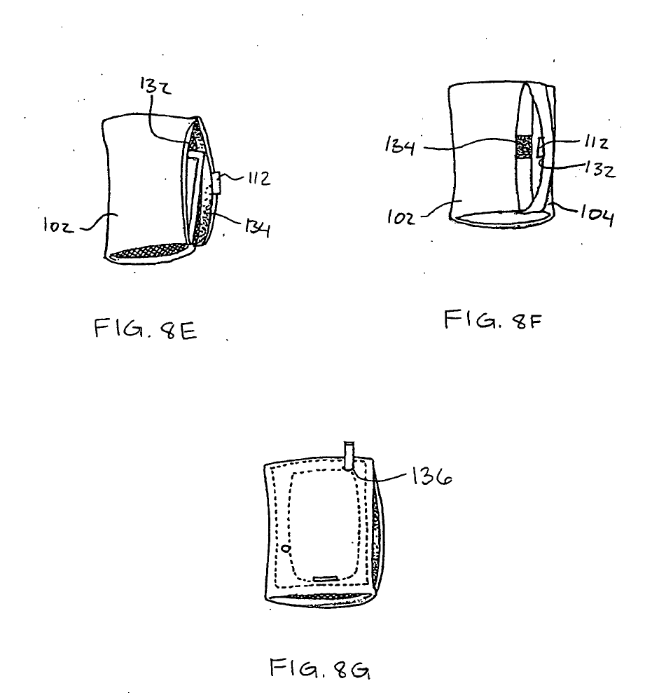

FIGS. 9 and 10 illustrate additional embodiments of the present invention according to FIG. 1. In FIG. 9, wallet 10 is illustrated in a closed position. It can be seen that, second body portion 22 is covered on one end, by a strap 70, which is connected to first body portion 20 and extends around to attach to outer surface 16. Also illustrated in FIG. 9 is a pocket 72, in which various items may be quickly accessed as desired.

FIG. 10 illustrates the embodiment according to FIG. 9, shown in an open position. Here, the interior of wallet 10 is similar to that illustrated in connection with FIG. 2. In this embodiment, the closure system may comprise, for example, a hook 72 and loop 74 type system. Strap 70 is also provided as a hook and loop type closure system. It should be noted however, that wallet 10 may be provided with any of the previously described closure systems as disclosed in connection with FIGS. 8A-8G and any combinations thereof.

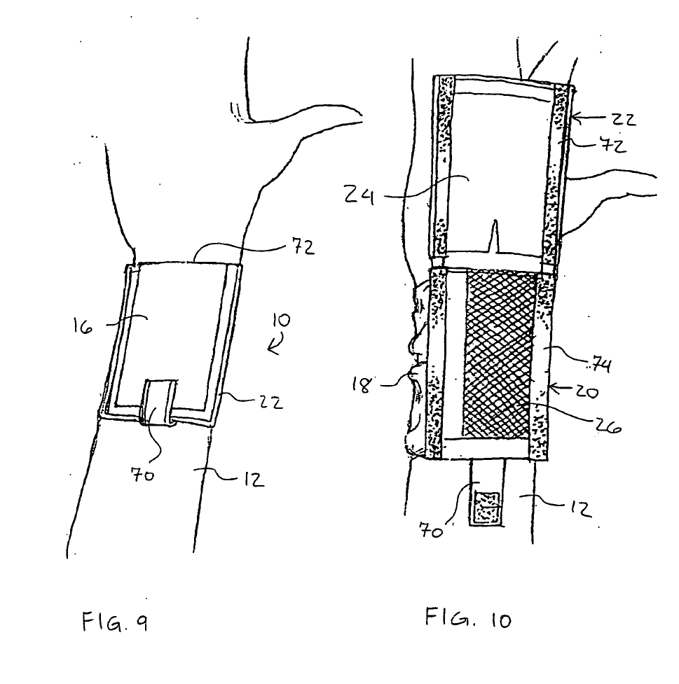

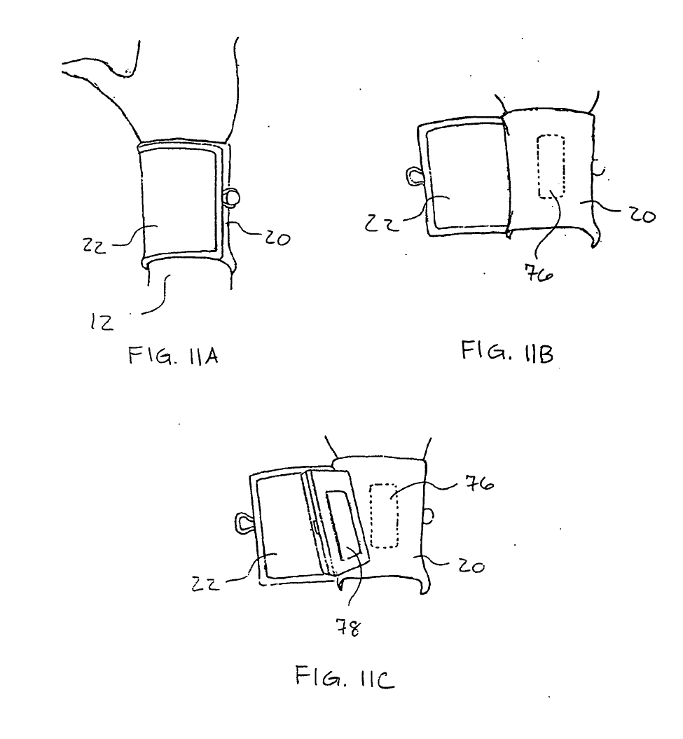

FIGS. 11A-11C illustrate still further embodiments of the present invention. In this embodiment, wallet 10 is provided with a second body portion 22 that may be displaced relative to the first body portion 20. Also illustrated is a button-type closure system, however, virtually any type of closure system, as previously discussed herein, may effectively be utilized.

As seen in FIGS. 11B and 11C, a magnetic strip 76 is provided on first body portion 20. Another magnetic strip 78 is attached to a device, such as a cellular telephone, that can effectively hold the device in place relative to the magnetic strip 76. The second body portion 20, may then be closed over top of the device to further secure the item.

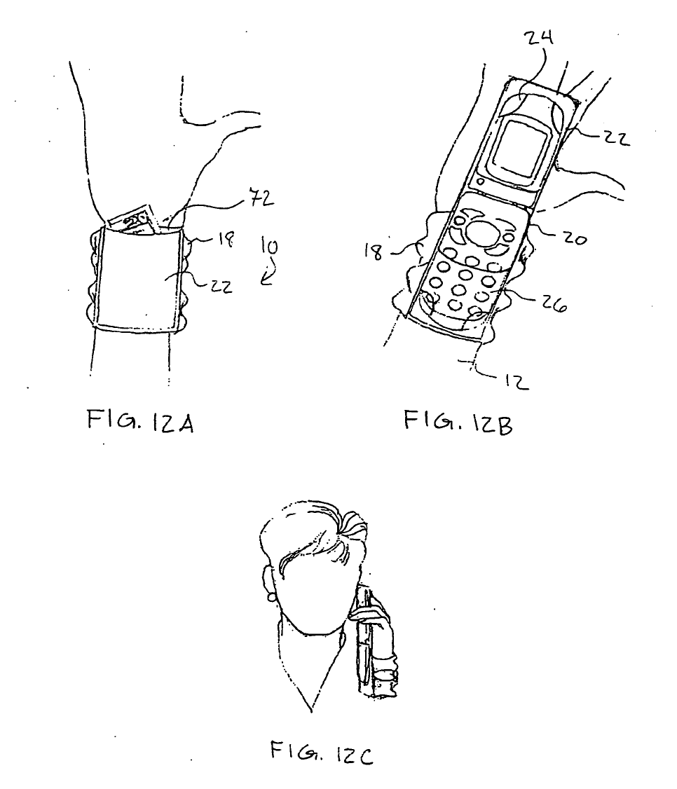

Turning now to FIGS. 12A-12C, another advantageous embodiment of the present invention is disclosed. Here, wallet 10 is adapted to receive a cellular telephone. A pocket 72 is also shown, similar to that described in connection with FIG. 9.

FIG. 12B shows the wallet 10 in an open position. Here, a lower part of the cell phone is positioned in pocket 26 located in first body portion 20. It is contemplated that pocket 26 will advantageously be formed of a transparent material for easy viewing of the keys on the cell phone. The cell phone is also attached to second body portion 22 at pocket 24, into which that other end of the cell phone is inserted.

As most flip-type cell phones are provided with a biasing force to bias the phone to a closed position, no closure system is necessary in this embodiment. However, any of the previous closure system may effectively be utilized as desired. In this manner, the cell phone, attached to the user's limb 12 may be accessed and used without the need of removing the cell phone from the wallet 10 as illustrated in connection with FIG. 12C. This provides the distinct advantage that the cell phone cannot be lost or misplaced because it is never removed from the wallet 10 but stays in constant contact with the user.

It is contemplated that virtually any number of the above-described features may be combined and recombined with any of the above embodiments. The concept however, of providing a secure, low-profile wallet however, may effectively be achieved by the various described embodiments. It is also contemplated that the wallet apparatus 10, 100 may be supplied in any number of shapes, comprising a wide variety of fabrics and patterns to be selected by the wearer. Wallet apparatus 10, 100 may also be provided as a water resistant material to be used, for example, in sports activities.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A wallet for carrying items to be secured to a user, said wallet comprising:
a body portion including at least one pocket therein for receiving the items to be secured;
said body portion including a first body portion maintained adjacent to the user, and a second body portion that may be displaced so as to provide access to the items;
an attachment mechanism for attaching the body portion to the user;
a closure system for maintaining at least an edge of the first and second body portions in proximity to each other to secure the items in the body portion;
said closure system including a first magnetic system in the first body portion and a corresponding second magnetic system in the second body portion such that at least the edges of the first and second body portions are maintained in a closed position relative to each other due to magnetic force between the first and second magnetic systems.

2. The wallet according to claim 1 wherein said second body portion is foldable to cover the first body portion such that the second body portion may be flipped outwardly relative to the first body portion to access the items.

3. The wallet according to claim 2 wherein the second foldable body portion is attached to the first body portion at a first end, the second foldable body portion including first and second sides and a second end portion.

4. The wallet according to claim 3 wherein the first and second sides of second foldable body portion contain the second magnetic system.

5. The wallet according to claim 4 wherein first and second sides of the first body portion contain the first magnetic system for engaging with the second magnetic system.

6. The wallet according to claim 5 wherein said pocket comprises a third magnetic system for engaging with the first magnetic system.

7. The wallet according to claim 1 wherein said pocket comprises, at least partially, a transparent material.

8. The wallet according to claim 1 wherein said pocket comprises, at least partially, an elastic material.

9. The wallet according to claim 8 wherein the elastic material comprises a mesh.

10. The wallet according to claim 1 wherein the first magnetic system comprises at least one magnet and the second magnetic system comprises at least one magnet.

11. The wallet according to claim 1 wherein the first magnetic system comprises at least one magnet and the second magnetic system comprises at least one metal component.

12. The wallet according to claim 11 wherein the at least one metal component comprises steel.

13. The wallet according to claim 12 wherein the at least one metal component comprises at least one steel ball.

14. The wallet according to claim 1 wherein said attachment mechanism comprises, at least partially, an elastic material.

15. The wallet according to claim 1 wherein said attachment mechanism comprises a wicking material.

16. The wallet according to claim 1 further comprising a second body portion pocket, located in the second body portion that is accessible when the wallet is in a closed position.

17. A wallet for carrying items to be secured to a user, said wallet comprising:
a body portion including at least one pocket therein for receiving the items to be secured;
said body portion including a first body portion maintained adjacent to the user, and a second body portion that may be displaced so as to provide access to the items;
an attachment mechanism for attaching the body portion to the user, said attachment mechanism comprising a wicking material;
a closure system for maintaining at least an edge of the second body portion in proximity to the first body portion to secure the items in the pocket;
said closure system selected from the group consisting of: a magnetic closure system, a button closure system, a snap closure system and combinations thereof.

18. A wallet for carrying items to be secured to a user's wrist, said wrist wallet comprising:
a body portion, having a longitudinal axis and including at least one pocket therein for receiving the items to be secured;
said pocket formed at least in part by a first body portion maintained adjacent to and extending circumferentially around a wrist of the user and comprising an elastic, wicking material, and a second body portion that is, displaceable relative to the first body portion, so as to provide access to the items;
a closure system for maintaining at least an edge of the second body portion in proximity to the first body portion to secure the items in the pocket;
said closure system selected from the group consisting of: a magnetic closure system, a button closure system, a snap closure system, a longitudinally extending zipper closure system and combinations thereof.

19. The wallet according to claim 18 wherein said closure system further includes a hook and loop closure system used in conjunction with at least one of the closure systems.

20. The wallet according to claim 18 wherein said closure system comprises a magnetic closure system that includes a first magnetic system in the first body portion and a corresponding second magnetic system in the second body portion such that at least the edge of the second portion is maintain in a closed position relative to the first body portions due to magnetic force between the first and second magnetic systems.

21. The wallet according to claim 18 further comprising a first magnetic strip located on the first body portion and a second magnetic strip for positioning on a device, such that the device is held in place relative to the first magnetic strip by means of magnetic attraction between the first and second magnetic strips.

22. A secure wallet apparatus for carrying a mobile device to be secured to a user's wrist, said wallet apparatus comprising:
a body portion, having a longitudinal axis and including a first body portion maintained adjacent to the user's wrist and a second body portion that is displaceable relative to the first body portion;
a first pocket, formed of a transparent material located in said first body portion;
a second pocket, formed of a transparent material located in said second body portion;
said first pocket designed to receive a first part of a mobile device and said second pocket designed to receive a second part of a mobile device;
wherein when said mobile device is inserted into said first and second pockets, the mobile device may be opened and used while simultaneously being attached to the user's wrist such that the device need never be removed from the wallet for normal use.

23. The wallet apparatus according to claim 22 wherein said mobile device comprises a mobile flip phone.
